(19) United States
(12) Patent Application Publication
(10) Pub. No.: US 2014/0072949 A1
(43) Pub. Date: Mar. 13, 2014

(54) METHOD FOR CHANGING MODES IN AN ELECTRONIC DEVICE

(71) Applicant: Unlock YourBrain GmbH, Berlin (DE)

(72) Inventors: Simon Smend, Berlin (DE); Felix Nienstädt, Trasisa (DE); Arndt Grossmann, Berlin (DE)

(73) Assignee: UnlockYourBrain GmbH, Berlin (DE)

(21) Appl. No.: 13/844,459

(22) Filed: Mar. 15, 2013

Related U.S. Application Data
(60) Provisional application No. 61/700,339, filed on Sep. 13, 2012.

(51) Int. Cl. G09B 5/02

(52) U.S. Cl. CPC G09B 5/02
USPC 434/362

(57) ABSTRACT

The present disclosure provides a method for activating an electronic device. The electronic device includes a user interface and a task application in communication with the user interface, wherein the task application compares a user action received through the user interface to the primary task answer and activates the user interface inactive mode if the user action matches that of the primary task answer. In addition, the task application may be configured to apply the user action in generating a subsequent primary task including selecting a degree of difficulty for the subsequent primary task intended to enable a user to activate the electronic device within a target range of time.

### CROSS-REFERENCE TO RELATED APPLICATIONS

This application incorporates by reference and claims priority to U.S. Provisional Application No. 61/700,339 filed on Sep. 13, 2012.

### BACKGROUND OF THE INVENTION

The present subject matter relates generally to a method for changing modes in an electronic device. More specifically, the present invention relates to an electronic device comprising a task application enabled to generate and display a task while the user interface is in a first, inactive, mode, receive user action information as a response to the displayed task, activate a second, active, mode in the user interface if the user action matches that of the task answer, and apply the user action information in generating a subsequent task intended to enable a user to activate the second mode within a target range of time.

Many people enjoy doing logic puzzles and mental exercise but do not have time to practice these problems in their busy lives. Whereas students are constantly engaging their minds in problem solving, many adults outside of an academic setting fail to exercise their brains in the same manner on a daily basis. Logic puzzles and mental exercise are available in various books (crossword puzzles, Sudoku, word find, brain teasers, etc.) as well as certain newspapers and electronic games, but these formats require the user to set aside time to play the games or practice the problems. As a result, many well-intentioned people fail to make the time to exercise their brains.

Even if a person schedules time to practice mental exercises, for example, twice a day for five minutes, there is a high risk the person will forget to initiate the exercise session at the appropriate time. In addition, proactive scheduling may be a disadvantage when the exercise disrupts a person's workflow or is regularly scheduled, yet falls at an inappropriate time.

In addition, the current mental exercise platforms, such as books and electronic games, fail to apply the answer received from the user in adapting the subsequent challenges. For example, if a person is working through a book of puzzles that comprise problems of various difficulties, the book does not automatically render feedback to the user instructing them to proceed to a more difficult or less difficult puzzle.

Accordingly, there is a need for a method directed to providing mental exercises dispersed throughout a person's daily activities such that the exercise do not disrupt normal activities or require a substantial amount of time to complete, and wherein the difficulty level of subsequent exercises is adjusted based on answers received from the user, as described and claimed herein.

### BRIEF SUMMARY OF THE INVENTION

The present disclosure provides a method for changing modes in an electronic device, particularly a method of using mental exercises to change the electronic device from an inactive mode to an active mode. The present disclosure provides an electronic device comprising a task application enabled to change modes a user interface based on user action relating to completing a mental exercise based task. Various examples of the device and method are provided herein.

In an embodiment, the method for changing modes in an electronic device includes providing a user interface, wherein the electronic device is adjustable between an inactive mode and an active mode. In a preferred embodiment, when the electronic device is in the inactive mode, a primary task and alternate task are displayed, wherein the primary task is generated by a task application. The primary task has an associated primary task answer and the alternate task has an associated alternate task answer. The method further includes receiving a user action though the user interface, comparing the user action received with the primary task answer and with the alternate task answer, activating the active mode if the user action matches the primary task answer or the alternate task answer, identifying information related to the user action, and applying the information related to the user action in generating a subsequent primary task. The step of applying the information related to the user action in generating a subsequent primary task may include selecting a degree of difficulty for the subsequent primary task intended to enable a user activate the portable electronic device within a target range of time.

In an example, the identified information comprises time data measured from a first time point of displaying the primary task to a second time point of receiving user action.

In another example, when the portable electronic device is in the inactive mode, it may be enabled to initiate emergency calls or some other limited functionality.

The primary task may be configured to improve a user's cognitive capacity. The primary task may include a mathematical problem, a foreign language problem, a vocabulary problem, a logic problem, a riddle problem, etc.

In an example, the primary task answer may include the user action of dragging a primary task answer object to a desired position on the user interface. In another example, the primary task answer may include the user action of entering a word or number on the user interface comprising a key pad enabled to received user action.

The present disclosure also provides for an electronic device adapted to embody the features and functions of the methods described herein. The portable electronic device includes a user interface in an inactive mode adapted to receive user action. The user interface is configured to provide a primary task and an alternate task, wherein the primary task has an associated primary task answer, wherein the alternate task has an associated alternate task answer. The portable electronic device further includes a task application in communication with the user interface, wherein the task application compares a user action received through the user interface to the primary task answer and to the alternate task answer. If the user action matches the primary task answer or the alternate task answer, the task application activates the user interface from inactive mode. In a preferred embodiment, if the alternate task answer is received, the electronic device is activated into an active mode having limited functionality. In addition, the task application may be configured to apply the user action that was received in generating a subsequent primary task including selecting a degree of difficulty for the subsequent primary task intended to enable a user to activate the portable electronic device within a target range of time.

In an example, the portable electronic device is a smartphone and, when the portable electronic device is in the inactive mode, it may be able to initiate emergency calls.

The primary task may be configured to improve a user's cognitive capacity. For example, the primary task may include a mathematical problem, a foreign language problem, a vocabulary problem, a logic problem, a riddle problem, etc.

In an example, the primary task answer may include the user action of dragging a primary task answer object to a desired position on the user interface. In another example, the primary task answer may include the user action of entering a word or number on the user interface.

In an embodiment, the primary task is displayed comprising at least two primary task answer prompts, wherein at least one of the primary task answer prompts is the primary task answer.

An advantage of the present method and device is that tasks are short and distributed naturally throughout the day every time a user wants to activate their electronic device. Also the tasks do not interfere with a user's daily activity. Typically, a user's activity is already disrupted when the user chooses to activate and engage with her portable electronic device. Therefore, the present method and device provides a task at the exact moment a user decides to switch her attention, thereby not disrupting a user's workflow or daily activities.

A further advantage of the present method and device is that the user does not have to be relied on to remember to practice mental exercise or to schedule time in the day to perform the mental exercises. Instead, the present method and device provides a way of dispersing small mental exercises for learning content throughout a user's day.

Another advantage of the method and device disclosed herein is that the user's input is taken into account when a subsequent task is generated. Therefore, the difficulty of the task is customized to the user. If the user is struggling with certain tasks the task application will generate easier tasks for the user to complete. Alternatively, if the user is excelling with certain tasks the task application will generate more difficult tasks in order to continually challenge the user's cognitive ability. In other words, the method provides an efficient mechanism for tracking a user's progress and adjusting the difficulty level of the displayed task accordingly. Further, the adjusting difficulty can be employed to prevent the task from taking too long to complete and preventing the user from accessing the electronic device in an appropriate time frame.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a flow chart illustrating an example of a method of activating a portable electronic device.

FIG. 2 is a schematic representation of the various functions that may be provided by the task application.

FIG. 3 is a flowchart illustrating an example of a method of activating a portable electronic device.

FIG. 4 is a front view of an example of a displayed primary task on a user interface.

FIG. 5 is a front view of an example of a displayed primary task on a user interface.

FIG. 6 is a front view of an example of a displayed primary task on a user interface.

FIG. 7 is a front view of an example of a displayed primary task on a user interface.

FIG. 8 is a front view of an example of a displayed primary task on a user interface.

### DETAILED DESCRIPTION OF THE INVENTION

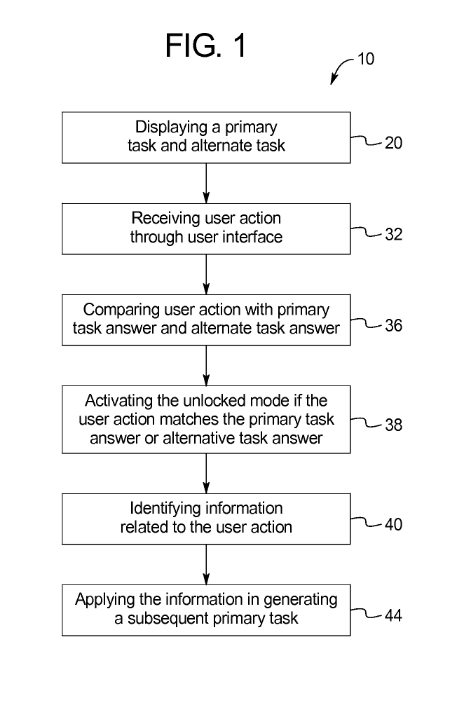

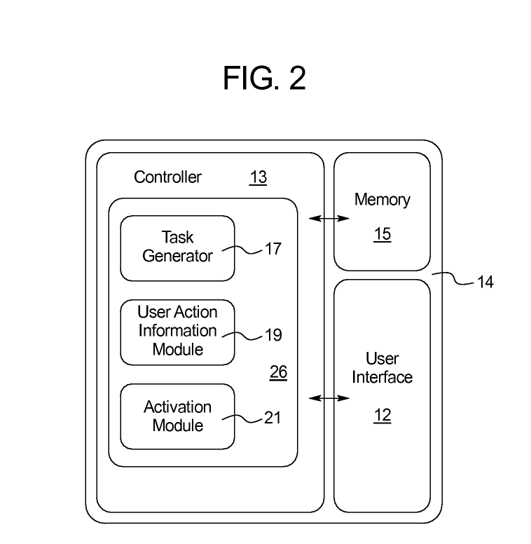

FIG. 1 illustrates an example of a method 10 for activating an electronic device 14 embodying the solutions provided herein. FIG. 2 illustrates a schematic view of an electronic device 14 adapted to perform the features and functions described herein. In the primary examples used herein, the electronic device 14 is a portable electronic device 14 embodied in a touchscreen-enabled smartphone. However, it is understood that the teachings provided may be applied to numerous variations of electronic devices 14, including desktop computers, remote controls, etc., as will be recognized by those skilled in the art based on the teachings herein.

As shown in FIG. 2, the electronic device 14 may include a user interface 12 in communication with a controller 13, which is in communication with memory 15. As further shown, the controller 13 may be adapted to run a task application 26, which causes the controller 13 to control the function of the electronic device 14 to provide the various features and functions described herein. The task application 26 is shown to embody a plurality of modules: a task generator 17; a user action identification module 19; and an activation module 21, which are illustrated as discreet elements merely for clarity in the description. It is understood that the task generator 17, the user action identification module 19, and the activation module 21 may be aspects of a unified task application 26 or may be broken into as many discrete elements as desired for purposes of accomplishing the solutions provided herein.

In the preferred embodiment described with respect to FIGS. 1 and 2, the user interface 12 is a touchscreen interface provided on an electronic device 14 such as a smartphone or similar mobile handheld computing device. The electronic device 14 is adjustable between an inactive mode and an active mode, for example between a locked mode and an unlocked mode. As used herein, “inactive mode” does not refer solely to a mode in which there is no functionality enabled in the electronic device 14, but more specifically to a mode in which the electronic device 14 is limited in functionality. In an example, an electronic device 14 in the inactive mode is enabled to initiate emergency calls. In other examples, an electronic device 14 in an inactive mode may be enabled to perform other limited functionality, for example, make use of camera functionality. While referred to herein generally as a distinction between an active mode and an inactive mode for purposes of clarity, it is understood that the solutions provided herein are applicable in any situation in which an electronic device 14 changes from a first state to a second state.

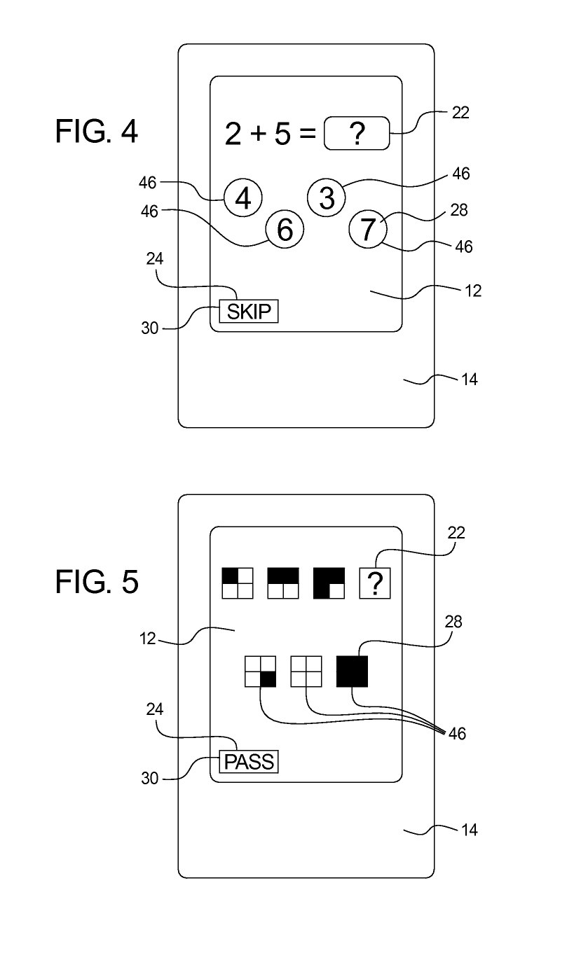

An example of the method 10 is shown in FIG. 1. The first step 20 in the method 10 is displaying a primary task 22 (FIGS. 4-7) and alternate task 24 (FIGS. 4-7) on the user interface 12, when the portable electronic device 14 is in an inactive mode. While method 10 is described with respect to the presently preferred embodiment in which the method includes providing both a primary task 22 and an alternate task 24, it is understood that there may be embodiments of the method 10 in which there is no alternate task 24. Excluding the alternate task 24 is a variation of the method 10 that will be understood by those skilled in the art based on the descriptions provided herein.

In the example shown in FIG. 1, the primary task 22 is generated by a task application 26. The primary task 22 has an associated primary task answer 28. In an example, challenging a user to solve the primary task 22 is intended to improve a user's cognitive capacity, though it is understood that variations in the purpose of the task may be implemented via the method 10. Similarly, the alternate task 24 is generated by a task application 26 and has an associated alternate task answer 30.

The primary examples used herein are directed to situations in which there is a single correct primary task answer 28. However, it is understood that there may be situations in which there is more than one primary task answer 28. For example, is the primary task 22 challenges the user to identify what the German word “arm” means in English, the user interface 12 may provide two correct primary task answers 28 (e.g., arm and poor) and two incorrect answers (house and street). Similarly, if the primary task 22 challenges the user to identify the picture of the person whose name is displayed (for example, drawn from a contact list in the electronic device 14), there may be more than one person's picture with the name (e.g., the name is Peter and there are pictures of two Peter's shown).

FIG. 2 illustrates an example of a user interface 12 in communication with the task application 26. In the example shown, a user communicates with the electronic device 14 through a user interface 12 and the user interface 12 is in direct communication with a task application 26. FIG. 2 further illustrates the various functions provided by the task application 26 via the task generator 17, the user action identification module 19, and the activation module 21. For example, a user may access a preference function in the task generator 17 portion of the task application 26 to personally customize the types of primary tasks the user desires to practice based on the user's learning goals. For example, a user could select mathematical and logic problems from the preference menu within the task application 26 if the user's learning goals include mathematic and logic problems.

Returning to FIG. 1, the second step 32 in the method 10 includes receiving a user action 34 though the user interface 12. User action 34 may be any action that allows a user to provide a primary task answer 28 or alternate task answer 30. For example, the user action 34 may include dragging a primary task answer object to a desired position on the user interface 12. Alternatively, or in addition to, the user action 34 may include entering a words and/or numbers on the user interface 12 comprising a keypad enabled to receive user action 34.

The third step 36 in method 10 includes comparing the user action 34 received with the primary task answer 28 and with the alternate task answer 30.

The fourth step 38 in method 10 includes activating the active mode if the user action 34 matches the primary task answer 28 or the alternate task answer 30. Alternatively, or in addition to, if the user action 34 matches the alternate task answer 30, a security question may be displayed on the user interface 12 for the user to answer before the user interface is activated. However, if upon comparing the user action 34 received with the primary task answer 28 and with the alternate task answer 30 and the user action 34 fails to match either the primary task answer 28 or the alternate task answer 30, the portable electronic device 14 remains in the inactive mode.

The fifth step 40 includes identifying the information related to the user action 34. For example, the information may include time data measured from the time the primary task 22 was displayed on the user interface 12 to the time when the user enters a user action 34, whether the user action was the primary task answer 28 or the alternate task answer 30, the degree of difficulty of the primary task 22, the degree of difficulty at which the user is consistently or currently performing in various categories of primary tasks 22, etc. For example, the information may include that at the present time the user is operating at a high difficulty level in primary tasks 22 involving mathematical problems, a low difficulty level in primary tasks 22 involving vocabulary problems, and a mid difficulty level in primary tasks 22 involving logic problems. The information may be constantly updated as the task application 26 receives more user actions 34. In other words, in a week's time, the information might change such that the user is now operating at a low level difficulty in primary tasks 22 involving mathematic problems, a mid level difficulty level in primary tasks 22 involving vocabulary problems, and a high difficulty in primary tasks 22 involving logic problems.

The sixth step 44 includes applying the information related to the user action 34 in generating a subsequent primary task 22. In one example, the step of applying the information related to the user action 34 in generating a subsequent primary task 22 includes selecting a degree of difficulty for the subsequent primary task 22 that is intended to enable a user to activate the portable electronic device 14 within a target range of time.

For example, the difficulty level of the primary task 22 may be adjusted based on the time data measured from the time the primary task 22 was displayed on the user interface 12 to the time when the user enters a user action 34. For example, the difficulty level could be lowered to keep the time spent solving the primary task 22 close to a target time value, e.g., 2.5 seconds. Alternatively, the difficulty level could be increased if the time data indicates the user is solving the primary task 22 in a time under the target time value, e.g., less than 2.5 seconds.

Further, the step of applying the information related to user action 34 may include repeating the same or similar primary tasks 22 that the user performed poorly on in the past, as well as repeating less often the same or similar primary tasks 22 that the user performed well on in the past.

In other examples, the difficulty level of the primary task 22 may be based on a user's prior interaction with the electronic device 14, but it may not be optimized to provide the user a primary task 22 adapted to be correctly answered under a target time value or within a target time range.

As described, the primary task 22 presented to the user may be based on the user's prior interaction with the electronic device 14. However, it is important to note that the prior interaction may not be the interaction immediately preceding the current primary task 22. For example, the method 10 may track the user's performance on specific vocabulary items, meaning that the method 10 tracks how well the user knows a specific word. The task application 26 can then adjust the difficulty for that specific vocabulary word based on the user's prior answers related to that word, not to other words. In such a case a subsequent primary task 22 would not necessarily be based the difficulty on the previous primary task 22, but on a previous primary task 22.

While described herein specifically with reference to adaptive versions of the systems and methods (i.e., instances in which the user's past performance influences future primary tasks 22), it is understood that embodiments of the systems and methods may be non-adaptive and may simply provide primary tasks 22 with no reference to prior user interaction. Such examples will be understood by those skilled in the art based on the descriptions provided herein.

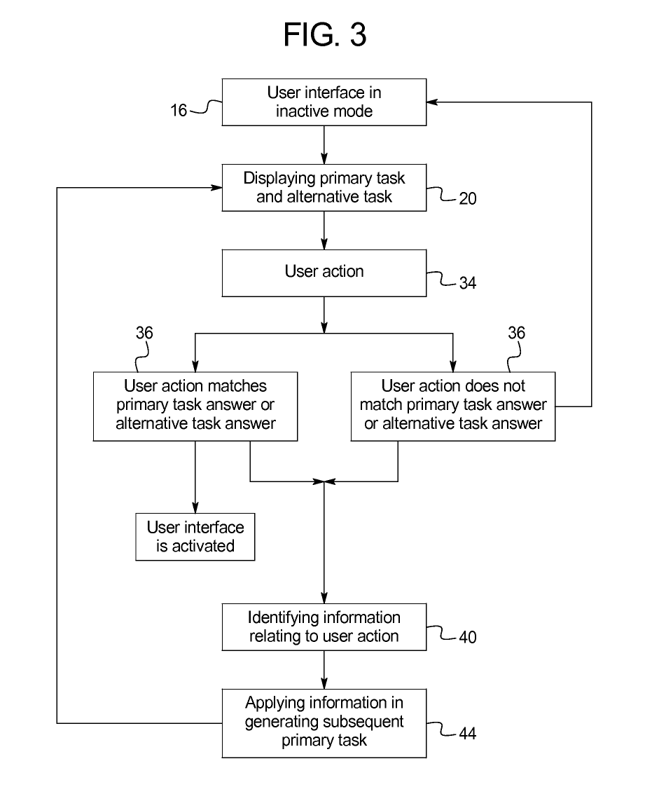

FIG. 3 is a flowchart illustrating an example of the method 10 of activating a portable electronic device 14. While the user interface 12 is in an inactive mode, a primary task 22 and alternate task 24 are displayed on the user interface 12. A user enters a user action 34. If the user action 34 matches the primary task answer 28 or the alternate task answer 30, the portable electronic device 14 is switched from an inactive mode to an active mode. If, however, the user action 34 does not match the primary task answer 28 or the alternate task answer 30, the portable electronic device 14 remains in an inactive mode. FIG. 3 also illustrates that regardless of whether the user action 34 matches the primary task answer 28 or the alternate task answer 30, the information relating to the user action 34 is identified and subsequently applied in generating a subsequent primary task 22.

when the electronic device is in the inactive mode, displaying a primary task comprising at least two primary task answer prompts, wherein the primary task is generated by a task application, wherein at least one of the primary task answer prompts is a primary task answer;

In an embodiment, when the electronic device is in the active mode, a primary task 22 is displayed comprising at least two primary task answer prompts 46, wherein at least one of the primary task answer prompts 46 is the primary task answer 28. In other words, the displayed primary task 46 may include, for example, four primary task answer prompts 46, one of which will be the primary task answer 28, and the remaining three primary task answer prompts 46 will correspond to incorrect answers to the primary task.

FIGS. 4-7 are examples of a displayed primary task 22 on a user interface 12. The primary task 22 can be any number of mental exercises including, but not limited to, questions or problems involving puzzles, logic, riddles, mathematics, vocabulary, spelling, letters, foreign language, face recognition, history, science, trivia, word games, or any combination thereof.

FIG. 4 is an example in which the primary task 22 is a mathematical problem that prompts the user to select the answer that corresponds to “2+5” from the possible answer choices “4,” “6,” “3,” and “7.” In this example, “4,” “6,” “3,” and “7” are primary task answer prompts 46 and “7” is the primary task answer 28. FIG. 4 also depicts the display of an alternate task 24 of “SKIP.” In this example, the primary task answer 28 corresponds to “7” and the alternate task answer 30 corresponds to “Skip.” If the user selects “7,” either by selecting the image of “7” on the user interface 12, or dragging the number “7” to a designated answer space, the user action 34 matches the primary task answer 28, and thus the portable electronic device would switch from a inactive mode to an active mode. If the user action 34 included selecting “SKIP,” the user action 34 matches the alternate task answer 30, and the portable electronic device 14 is switched from an inactive mode to an active mode. However, if the user action 34 did not match the primary task answer 28 of “7” or the alternate task answer 30 of “SKIP,” then the portable electronic device 14 remains in an inactive mode. The information related to the user action 34 is identified and applied in generating a subsequent primary task 22. For example, if the user action 34 did match the primary task answer 28, the subsequent primary task 22 generated may be more difficult owing to the success of the user in solving the mathematical problem. Alternatively, for example, if the user action 34 did not match the primary task answer 28 or alternate task answer 30, the subsequent primary task 22 generated may be less difficult owing to the failure of the user in solving the mathematical problem.

FIG. 5 is an example of a primary task 22 and alternate task 24 provided through a user interface 12. In this example, the primary task 22 is a logic-based problem where the user can select one of three answer options provided on the second row. In this example, the three figures on the second row are primary task answer prompts 46 and last option in the second row, in which the entire square is blacked-out, is the primary task answer 28. Alternatively, the user may select the alternate task answer 30 of “PASS.”

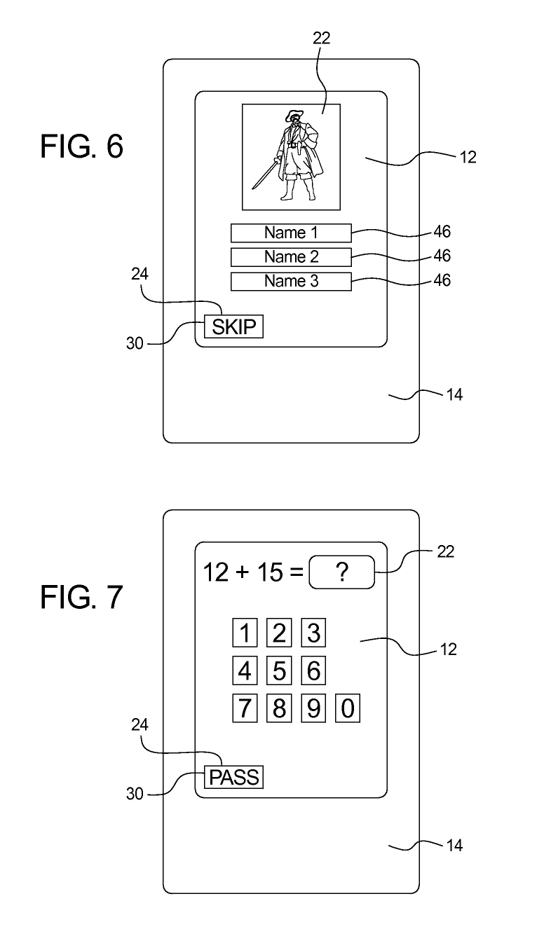

FIG. 6 is an example of a primary task 22 and alternate task 24 provided through a user interface 12. In this example, the primary task 22 is a name-identifying problem based on the image provided where the user can select one of three primary task answer prompts 46 that may correspond to the name of the image. Alternatively, the user may select the alternate task answer 30 of “SKIP.” The primary task answer 28 is the name corresponding to the image. This type of primary task 22 could include vocabulary problems, foreign language problems, and name association problems. For example, the primary task 22 could include a photo of a person of which the user must select their name from possible answer choices. Alternatively, the primary task 22 could include an image of a cat and the user must select the German word for cat among various German vocabulary answer choices. It is understood that instead of selecting from two or more answer choices, the user action 34 may consist of entering in a word or phrase into a displayed or actual keypad.

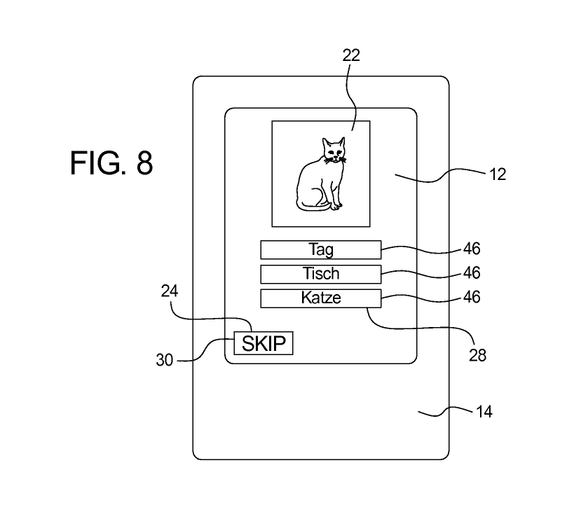

FIG. 7 is an example of a primary task 22 and alternate task 24 provided through a user interface 12. In this example, the primary task 22 is a mathematical problem where the user can select an answer by using a displayed or actual keypad. Alternatively, the user may select the alternate task answer 30 of “PASS.” The primary task answer 28 is “27” which may be entered on the keypad as “2” followed by “7.”

FIG. 8 is an example of a primary task 22 and alternate task 24 provided through a user interface 12. In this example, the primary task 22 is a foreign language vocabulary problem. The primary task answer prompts 46 include “Tag,” “Tisch,” and “Katze.” The primary task answer is “Katze” which is the German word “cat.” Alternatively, the user may select the alternate task answer 30 of “SKIP.”

The present disclosure also provides for a portable electronic device 14 comprising a user interface 12 in an inactive mode adapted to receive user action 34. The user interface 12 is configured to provide a primary task 22 and an alternate task 24, wherein the primary task 22 has an associated primary task answer 28, wherein the alternate task 24 has an associated alternate task answer 30. The device also includes the task application 26 in communication with the user interface 12. As described above, the task application compares the user action 34 received through the user interface 12 to the primary task answer 28 and to the alternate task answer 30. If the user action 34 matches the primary task answer 28 or the alternate task answer 30, the task application 26 activates the user interface 12 from an inactive mode. The task application 26 is configured to apply the user action 34 in generating a subsequent primary task 22 including selecting a degree of difficulty for the subsequent primary task 22 intended to enable a user to activate the portable electronic device 14 within a target range of time.

It should be noted that various changes and modifications to the embodiments described herein will be apparent to those skilled in the art. Such changes and modifications may be made without departing from the spirit and scope of the present invention and without diminishing its attendant advantages. For example, various embodiments of the method and portable electronic device may be provided based on various combinations of the features and functions from the subject matter provided herein.

We claim:

1. A method for activating an electronic device comprising:
providing an electronic device including a user interface, wherein the electronic device is adjustable between an inactive mode and an active mode;
when the electronic device is in the inactive mode, displaying a primary task, wherein the primary task is generated by a task application, wherein the primary task has an associated primary task answer;
receiving a user action through the user interface;
comparing the user action received with the primary task answer;
activating the active mode if the user action matches the primary task answer;
identifying information related to the user action; and
applying the information related to the user action in generating a subsequent primary task.

2. The method for claim 1 further wherein:
when the electronic device is in the inactive mode, further displaying an alternate task having an associated alternate task answer;
comparing the user action received with the primary task answer and with the alternate task answer; and
activating the active mode if the user action matches the primary task answer or the alternate task answer.

3. The method of claim 1 wherein the step of applying the information related to the user action in generating a subsequent primary task includes selecting a degree of difficulty for the subsequent primary task intended to enable a user to activate the portable electronic device within a target range of time.

4. The method of claim 1 wherein the information comprises time data measured from a first time point of displaying the primary task to a second time point of receiving user action.

5. The method of claim 1 wherein the electronic device in the inactive mode is enabled to initiate emergency calls.

6. The method of claim 1 wherein the primary task is configured to improve a user's cognitive capacity.

7. The method of claim 1 wherein the primary task comprises a mathematical problem.

8. The method of claim 1 wherein the primary task comprises a foreign language problem.

9. The method of claim 1 wherein the primary task comprises a logic problem.

10. The method of claim 1 wherein the primary task answer comprises the user action of dragging a primary task answer object to a desired position on the user interface.

11. The method of claim 1 wherein the primary task answer comprises the user action of entering a word or a number on the user interface comprising a keypad enabled to receive user action.

12. An electronic device comprising:
a user interface in an inactive mode adapted to receive a user action, wherein the user interface is configured to provide a primary task, wherein the primary task has an associated primary task answer; and
a task application in communication with the user interface, wherein the task application compares the user action received through the user interface to the primary task answer, wherein, if the user action matches the primary task answer, the task application activates the user interface from the inactive mode, wherein the task application identifies information related to the user action and applies the information related to the user action in generating a subsequent primary task.

13. The device of claim 12 wherein the user interface in an inactive mode is further adapted to provide an alternate task having an associated alternate task answer; and the task application compares the user action received through the user interface to the primary task answer and to the alternate task answer, wherein, if the user action matches the primary task answer or the alternate task answer, the task application activates the user interface from the inactive mode.

14. The device of claim 12 further wherein the task application is configured to apply the user action in generating a subsequent primary task including selecting a degree of difficulty for the subsequent primary task intended to enable a user to activate the electronic device within a target range of time.

15. The device of claim 12 wherein the electronic device in the user interface inactive mode is enabled to initiate emergency calls.

16. The device of claim 12 wherein the primary task is configured to improve a user's cognitive capacity, the primary task comprises a mathematical problem, the primary task comprises a foreign language problem, or the primary task comprises a logic problem.

17. The device of claim 12 wherein the primary task answer comprises the user action of dragging a primary task answer object to a desired position on the user interface.

18. The device of claim 12 wherein the primary task answer comprises the user action of entering a word or a number on a user interface comprising a keypad enabled to receive user action.

19. A method for activating an electronic device comprising:
providing an electronic device including a user interface, wherein the electronic device is adjustable between an inactive mode and an active mode;
when the electronic device is in the inactive mode, displaying a primary task comprising at least two primary task answer prompts, wherein the primary task is generated by a task application, wherein at least one of the primary task answer prompts is a primary task answer;
receiving a user action through the user interface;
comparing the user action received with the primary task answer; and
activating the active mode if the user action matches the primary task answer.

20. The method for claim 19 further wherein:
when the electronic device is in the inactive mode, further displaying an alternate task having an associated alternate task answer;
comparing the user action received with the primary task answer and with the alternate task answer; and
activating the active mode if the user action matches the primary task answer or the alternate task answer.
